(19) United States
(12) Patent Application Publication
(10) Pub. No.: US 2013/0013526 A1
(43) Pub. Date: Jan. 10, 2013

(54) SOCIAL NETWORKING JOB MATCHING TECHNOLOGY

(76) Inventors: Stéphane LE VIET, Paris (FR); Julie SEGUELA, Paris (FR)

(21) Appl. No.: 13/543,616

(22) Filed: Jul. 6, 2012

Related U.S. Application Data
(60) Provisional application No. 61/504,993, filed on Jul. 6, 2011.

(51) Int. Cl. G06Q 10/06

(52) U.S. Cl. 705/319

(57) ABSTRACT

Recruiting technology techniques are provided herein that match offers, such as jobs, with candidates, such as individuals, and vice versa, using the data available in social media profiles. Further, such recruiting technology uses semantic and statistical algorithms to reduce offer descriptions, such as job descriptions and candidate profiles into universal types. Two examples of universal types are job descriptions referred to herein as Job DNA™ and candidate descriptions referred to herein as Candidate DNA™.

### CROSS REFERENCE TO RELATED APPLICATIONS

This patent application claims priority from U.S. Provisional Patent Application Ser. No. 61/504,993, SOCIAL NETWORKING JOB MATCHING TECHNOLOGY, filed Jul. 6, 2011, the entirety of which is incorporated herein by this reference thereto.

### BACKGROUND OF THE INVENTION

1. Technical Field

This invention relates generally to the field of recruiting technology. More specifically, this invention relates to optimization techniques for recruiting for jobs leveraging social network or social media technology and using semantic and statistical algorithms.

2. Description of the Related Art

As online services have become more and more accessible for both the supply side and the demand side of essentially any market, online recruiting technology is no exception. For example, as any individual seeking employment most likely knows, he or she can upload his or her resume on a job recruiting website in the hopes of a job hirer reading the resume and contacting him or her for an interview that ultimately leads to being hired.

As well, as social network environments become more ubiquitous, some service providers have offered job recruiting services that leverage the social network platform. For example, Work4 Labs offers an application titled, Work for Us app, that allows a company to install such application on the company's Facebook™ (“Facebook”) page and upload the open positions of the company. Over 6,000 companies currently use the application, including Citibank, Accenture, PwC, KPMG, Roche, P&G, and Intel. The application currently allows companies to post jobs on their page as well as receive applications from users.

### SUMMARY OF THE INVENTION

Recruiting technology techniques are provided herein that match offers, such as jobs, with candidates, such as individuals, and vice versa, using the data available in social media profiles. Further, such recruiting technology uses semantic and statistical algorithms to reduce offer descriptions, such as job descriptions and candidate profiles into universal types. Two examples of universal types are data structures of job descriptions referred to herein as Job DNA™ (“Job DNA”) and data structures of candidate descriptions referred to herein as Candidate DNA™ (“Candidate DNA”).

### BRIEF DESCRIPTION OF THE DRAWINGS

FIG. 1 is a flow diagram showing how Job DNA is generated, according to an embodiment;

FIG. 2 is a flow diagram showing how Candidate DNA is generated, according to an embodiment;

FIG. 3 is a schematic diagram showing a comparison of when Job DNA and Candidate DNA are not employed in job recruiting on a Facebook platform and when Job DNA and Candidate DNA are employed in job recruiting on a Facebook platform, according to an embodiment;

FIG. 4 is a schematic diagram showing a comparison of when Job DNA and Candidate DNA are not employed in job referring on a Facebook platform and when Job DNA and Candidate DNA are employed in job recruiting on a Facebook platform, according to an embodiment;

FIG. 5 is a sample Facebook page of Company A showing posted job and an icon for finding jobs matching a profile, according to an embodiment;

FIG. 6 is a sample Facebook page of Company A showing a message box asking the user for permission to access the Facebook profile data of the user, according to an embodiment;

FIG. 7 is a sample Facebook page of Company A showing a request for permission dialog that is similar to that which is used for other Facebook applications, according to an embodiment;

FIG. 8 is a sample Facebook page of Company A showing a message box prompting the user to increase the accuracy of the application by authorizing access to the LinkedIn profile of the user, according to an embodiment;

FIG. 9 is a sample Facebook page of Company A showing a message box that depicts how the authorization for LinkedIn occurs within Facebook and in a manner with which the user already may be familiar and comfortable, according to an embodiment;

FIG. 10 is a sample Facebook page of Company A showing the light bulb icon in the upper right corner is lit, which signals that the authorization process is complete and that the jobs are reordered based on their relevance to the user, according to an embodiment;

FIG. 11 is a sample page on Facebook of a job posting and of a list of friends on Facebook who best match the particular job posting, according to an embodiment;

FIG. 12 is a sample page on Facebook of a job posting, a list of friends that best match the particular job posting, and a link to LinkedIn contacts of the user, according to an embodiment;

FIG. 13 is a sample message box asking the user for log in information to the LinkedIn account of the user, according to an embodiment;

FIG. 14 is a sample page on Facebook of a job posting and of a list of friends in LinkedIn who best match the particular job posting, according to an embodiment;

FIG. 15 is a sample page on Facebook that has a dialog box on top that enables the user to send a custom referral within seconds via Facebook or LinkedIn, according to an embodiment; and

FIG. 16 is a block schematic diagram of a system in the exemplary form of a computer system according to an embodiment.

### DETAILED DESCRIPTION OF THE INVENTION

Recruiting technology techniques are provided herein that match offers, such as jobs, with candidates, such as individuals, and vice versa, using the data available in social media profiles. Further, such recruiting technology uses semantic and statistical algorithms to reduce offer descriptions, such as job descriptions and candidate profiles into universal types. Two examples of universal types are job descriptions referred to herein as Job DNA™ and candidate descriptions referred to herein as Candidate DNA™.

It should be appreciated that while particular details in the context of job recruiting are discussed, embodiments herein may encompass two other universal types that may need to be matched in the optimized ways as in accordance with embodiments herein. For example, a first universal type may be types of food one likes to eat. A second universal type may be one of many recipes. Then, using embodiments herein, one may enter types of food and in return receive a list of relevant recipes. As another example, a first universal type may be a description of issues one is interested in learning about. A second universal type may be one or more relevant articles or books. Thus, using embodiments herein, one may enter a description of parenting challenges and in return receive a list of relevant parenting articles and books.

Further, it should be appreciated that particular details about Facebook (Palo Alto, Calif.; herein referred to as “Facebook”) and LinkedIn (Mountain View, Calif.) of the LinkedIn Corporation (“LinkedIn”) are discussed. However, such particular details are by way of example only and are not meant to be limiting. Other social media profile data or other social network profile may be used as well.

### Job DNA™

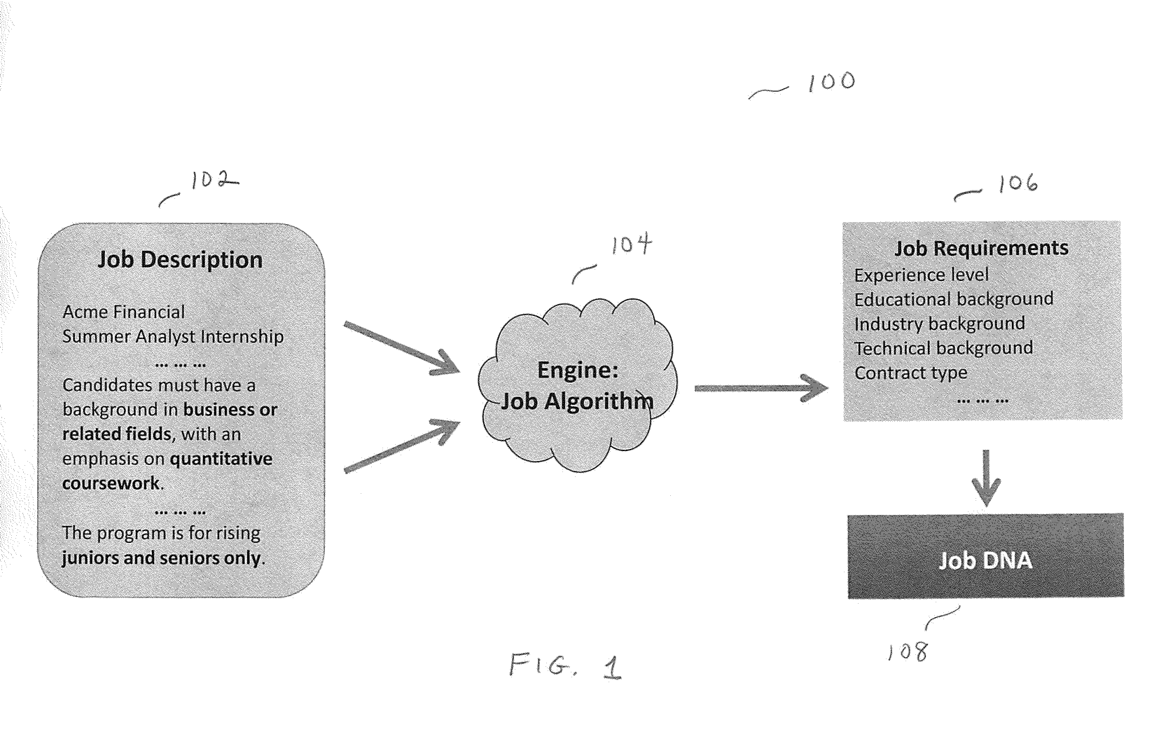

An embodiment can be understood with reference to FIG. 1, which shows a high level configuration 10 for generating job DNA.

Step One:

In an embodiment, an engine or processor, such as for example job engine 104, takes in input data 102, such as but not limited to a job description, parses such input data, and identifies one or more keywords that are relevant in the contexts in which they are used. To get to those keywords, pre-processing may include removing words, referred to as “stop-words”, which do not carry sense. Embodiments of these stop-words can be but are not limited to grammatical connectors (articles, prepositions). Remaining words may be then weighted according to a relevant metric. This metric can be but is not limited to the word occurrence frequency compared to the frequency of documents containing this word in a set of documents referred to as “corpus”. In such an embodiment, the corpus may be but is not limited to the set of all job descriptions stored by the application. Such a comparison can be but is not limited to a division between those two frequencies. Each keyword is thus associated to a weight that accounts for its importance relative to the corpus. This weight is positively correlated to term frequency and negatively correlated to document frequency. An example can be understood with reference to FIG. 1, where job description 102 is shown to contain data about a company (Acme Financial), a position (Summer Analyst Internship), etc. Further, job description 102 contains a descriptive sentence indicating that candidates must have a background in business or related fields, with an emphasis on quantitative coursework. In this example, it is shown that the one or more keywords are in bold type and are “business or related fields” and “quantitative coursework.” Further, the example job description 102 also shows a requirement that the program is for rising juniors and seniors only. It should be appreciated that the words, juniors and seniors only, are in bold type. This is because such words were identified by job engine 104 as being keywords that are relevant in the context in which they are used, which, in this example is, but is not limited to, the context of analyst.

It should be appreciated that one skilled in the art would readily recognize that parsing and keyword identification algorithms, such as but not limited to semantic and statistical algorithms, are readily available and may be employed herein to achieve such results. Such semantic and statistical algorithms need not be further taught herein.

Step Two:

In an embodiment, job engine 104 subsequently translates such relevant keywords into set components. For example, the above-mentioned semantic and statistical algorithms may parse job description 102 and generate at least a list of job requirements 106. For example, such list may contain but is not limited to the following terms: Experience level, Educational background, Industry background, Technical background, Contract type, and so on.

Step Three:

In an embodiment, such generated set components make up a particular representation of the particular description. Thus, in our example, such set components or job requirements 106 make up a particular DNA or job DNA 108. The individual, standardized components of the job are finally synthesized into a single classification: the ‘Job DNA™’. Job DNA™ may contain both semantics, and statistical data about the job description. Semantics values may be either computed from the job corpus or already included in some of the fields of the job description. Semantics values may include but are not limited to seniority level required, country, and language. Statistical data consist in a set of keywords extracted from the description and associated to a coefficient illustrating the importance of said word, as stated in Step One. Thus, any company posting a job description can have a job DNA for that particular job.

### Candidate DNA™

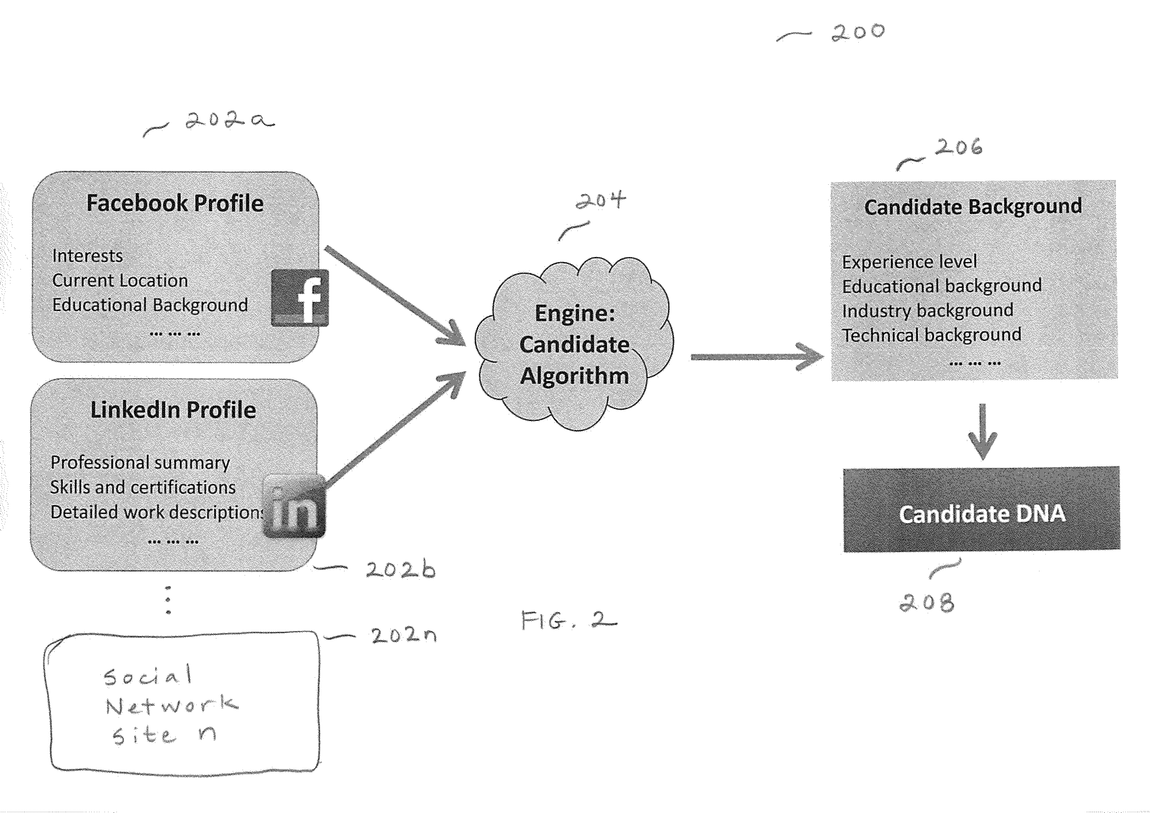

An embodiment can be understood with reference to FIG. 2, which shows a high level configuration 200 for generating candidate DNA.

Step One:

In an embodiment, a candidate engine or processor 204 parses and/or identifies professional data in user profiles and guesses or computes complete information to modify or amend any professional information that is incomplete. For example, suppose a user entered “programmer” and a standardized component is “computer programmer.” Then, in accordance with embodiments herein, candidate engine 204 may add the term, computer, to precede the term, programmer. Such example is meant for illustrative purposes and is not meant to be limiting. Further, it should be appreciated that in an embodiment, candidate engine 204 may start off as the same engine as job engine 104, however, for the purposes of discussion herein, it is assumed that candidate engine 204 primarily is given descriptive data that represents candidates or individuals who may be looking for work. Further, it should be appreciated that in an embodiment candidate algorithm 204 employs known semantic and statistical algorithms that are adapted to identify particular data such as but not limited to professional data from user profiles and semantically and statistically fill in missing data.

Referring to FIG. 2, an example is shown where candidate engine 204 receives user profile data from a Facebook profile 202a, user profile data from a profile 202b by LinkedIn, and user profile data from an nth social network profile 202n. It should be appreciated that the particular details of Facebook and LinkedIn are by way of example only and are not meant to be limiting.

Step Two:

In an embodiment, candidate engine 204 compiles existing and filled-in data from profiles 202a-202n into data components, e.g. components that are considered standardized in the given field of endeavor. Also information from other sources may be added to this data. Such sources may be but are not limited to public or restricted information that can be found on the internet or any other network or database. Such information may be but is not limited to information about the companies at which the candidate worked, about the schools or courses attended by the candidate or degrees he completed. Candidate information can also be enhanced by the information found in other profiles. Such profiles may be but are not limited to connections of the candidate in any social network. For example, such data components may contain but are not limited to Experience level, Educational background, Industry background, Technical background, and so forth. It should be appreciated that in an embodiment, candidate components may be identical to some corresponding job components.

Step Three:

In an embodiment, standardized components of the profiles are synthesized into a single classification: ‘Candidate DNA™ 208. This ‘Candidate DNA’ may be similar in terms of structure to the ‘Job DNA’ described in the previous section. Therefore, it may contain semantics and statistical information that can be mapped to the ‘Job DNA’ for comparison and matching purposes. As far as semantics are concerned, it may but is not limited to include information about seniority level, work country, and language. The statistical part of the ‘Candidate DNA’ may contain a list of keywords associated with a weight that takes into account their relative importance in the context of the job corpus and their importance in the user profiles.

### Job DNA™ and Candidate DNA™ Matching

One goal sought after extracting ‘Job DNA’ and ‘Candidate DNA’ is to evaluate the relevance of a match between a given job and a given candidate. Thus, in an embodiment, such matching may be done through any algorithm comparing datasets. Such an algorithm may be but is not limited to the computation of a score from distances between the values of the common components of the candidate DNA and the job DNA, as well as the comparison of other statistic or semantic information between the candidate and the job.

### A Feature for Candidates—Smart Sort

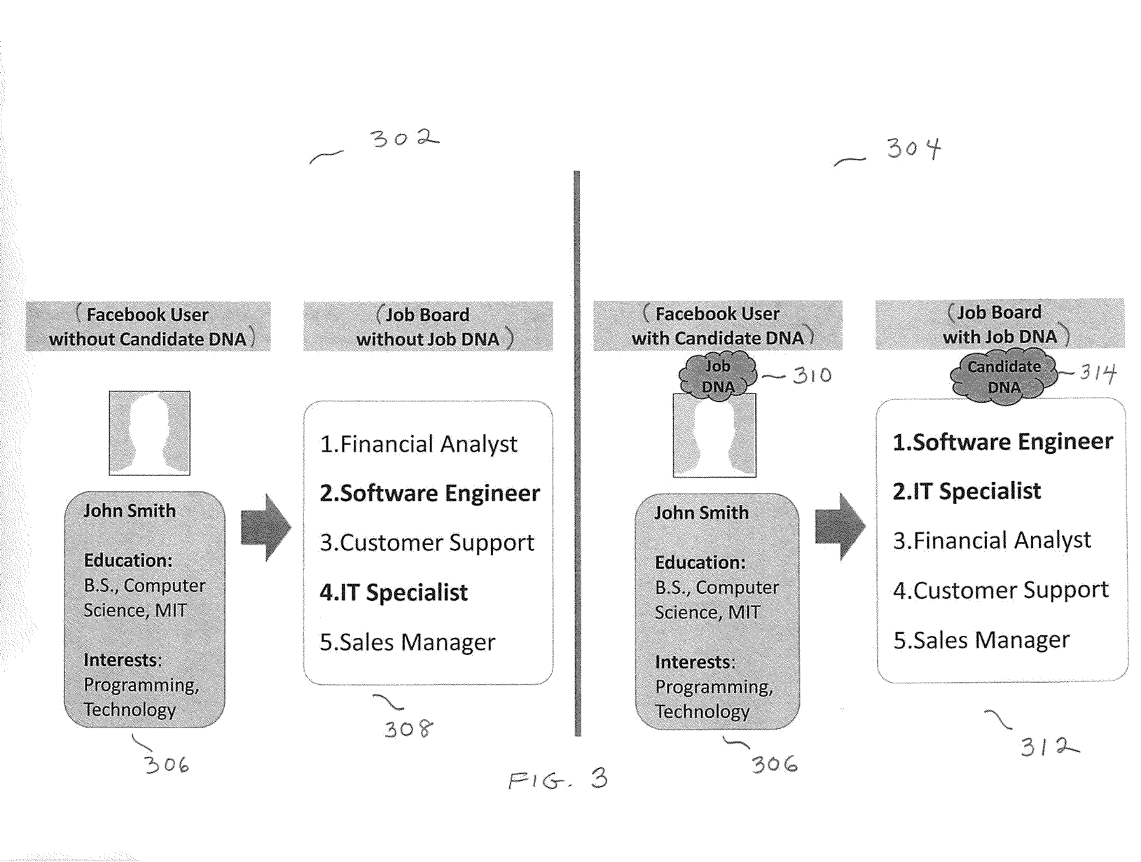

It should be appreciated that the above-described technology for generating job DNA and candidate DNA underlies two candidate-side features. One such feature is an intelligent sorting process, referred to herein as “smart sort,” which ranks many jobs against a user's Facebook profile and/or other social media profile, such as but not limited to LinkedIn. An embodiment can be understood with reference to FIG. 3. The left-hand side 302 shows how prior art methods without job engine 104 and candidate engine 204 results in the user seeing or receiving a randomly ordered list of jobs when they visit a company's job board.

In contrast and as shown on the right-hand side 304, using embodiments herein that employ job engine 104 and candidate engine 204, the jobs on the board are automatically reordered based on the data in the particular user's one or more profiles.

Thus, in the examples shown, in accordance with prior art techniques, John Smith may have a user profile 306 and may view job postings 308 on a job board, but the order of such job postings 308 is not based on the profile data 306 of John Smith. In contrast and in accordance with embodiments herein, the same profile of John Smith 306 is processed by job engine 104, which derives a candidate DNA 314 for John Smith. Subsequently and also in accordance with embodiments herein, job DNA data structures 310 were generated for particular job postings. Thus, embodiments herein match candidate DNA 314 with one or job DNAs 310 and based on such comparisons, order the list of job postings 312 in a particular order that is most relevant to John Smith.

### A Feature for Candidates—Smart Share

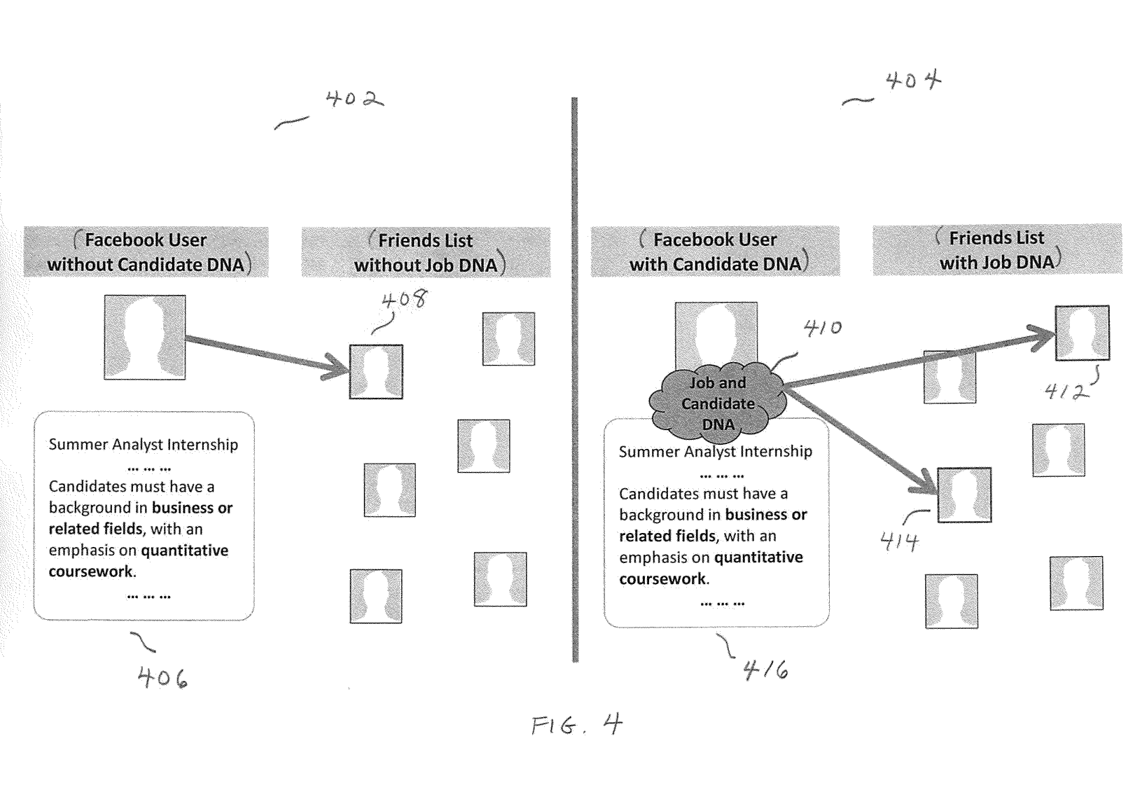

One other candidate-side feature that may result from the technology of generating job DNA and candidate DNA is an intelligent process, referred to herein as “smart share,” which matches a job with the Facebook friends and/or LinkedIn contacts of a particular user. An embodiment can be understood with reference to FIG. 4. The left-hand side 402 shows how with prior art techniques without generating job DNA and candidate DNA, users guess whom of their hundreds of friends is qualified for a job, the uncertainty contributing to reducing users' willingness to refer as well as their referral accuracy.

In contrast and as shown on the right-hand side 404, using embodiments herein, highly accurate referral suggestions are determined and presented to the user, leaving the user with the only task of referring the job itself.

Thus, according to prior art techniques, a user viewing a particular job posting, such as Summer Analyst Internship 406, for example, and wanting to refer such job posting to one or more friends on his or her social network account may have to search for friends starting with a random friend 408. In contrast and in accordance with embodiments herein, given a job posting. e.g. the job posting of Summer Analyst Internship 416, associated with both the job DNA and the candidate DNA 410 of the particular user, the user is presented with two particular friends 412 and 414 that best match job posting 416.

### Smart Sort Workflow

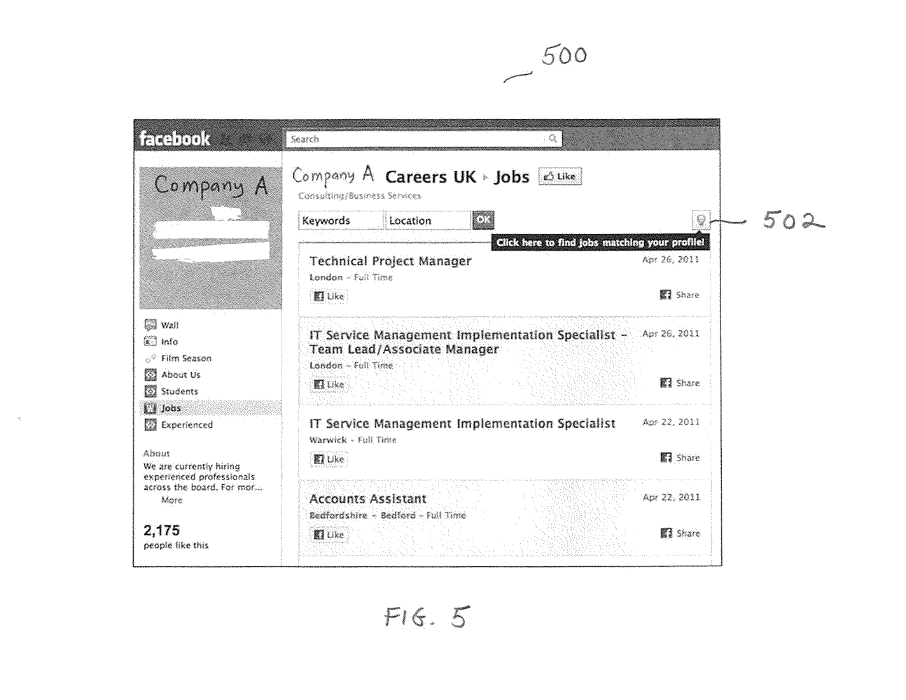

An embodiment can be understood with reference to FIG. 5. FIG. 5 is a sample Facebook page of Company A 500 showing posted job and a light bulb icon 502 for finding jobs matching a profile, according to an embodiment. Users are prompted to authorize job engines 104 and candidate engine 204 to activate their respective functionality by clicking on unlit light bulb 502 on the upper right corner of the job board.

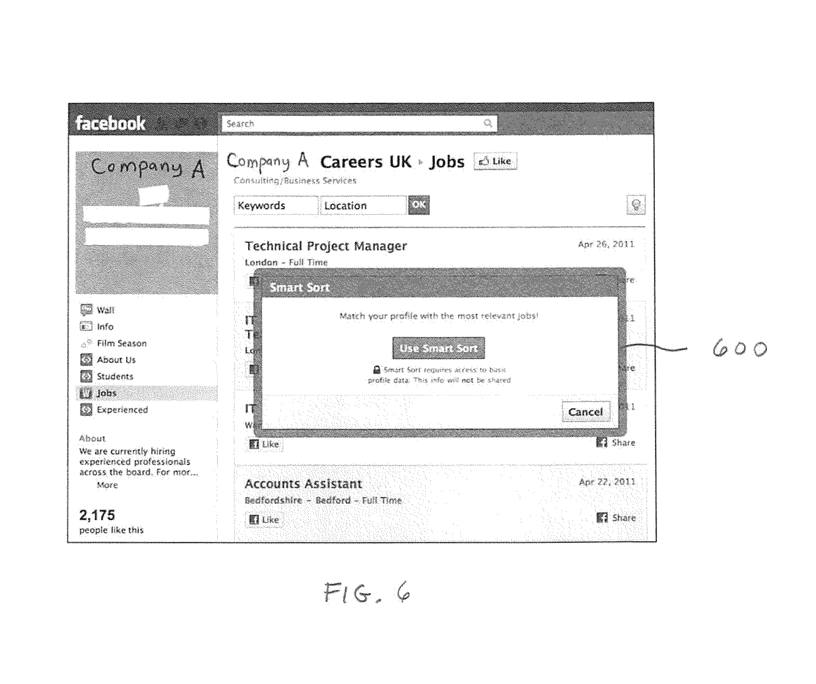

An embodiment can be understood with reference to FIG. 6. FIG. 6 is sample Facebook page of Company A of FIG. 5 further showing a message box 600 asking the user for permission to access the Facebook profile data of the user, according to an embodiment. Thus, as is shown, in an embodiment, the first step of the authorization process grants the application encompassing job engine 104 and candidate engine 204 access to the Facebook profile data of the user. In an embodiment, throughout the job recruiting process the candidate is made fully aware of what data is shared.

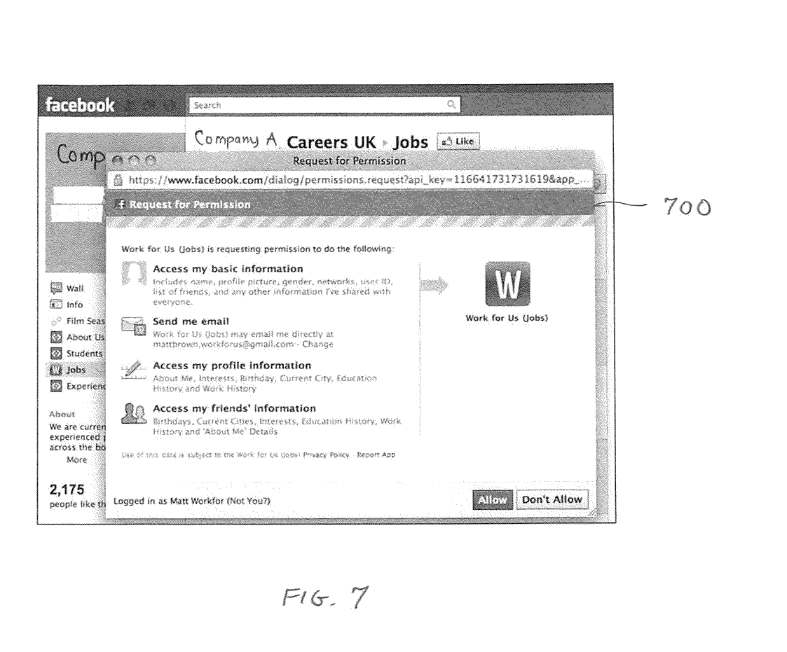

An embodiment can be understood with reference to FIG. 7. FIG. 7 is sample Facebook page of Company A 500 further showing a request for permission dialog 700 that is similar to dialogs used for other Facebook applications, according to an embodiment. For example, the Facebook authorization dialog is similar to that which is used for Facebook games.

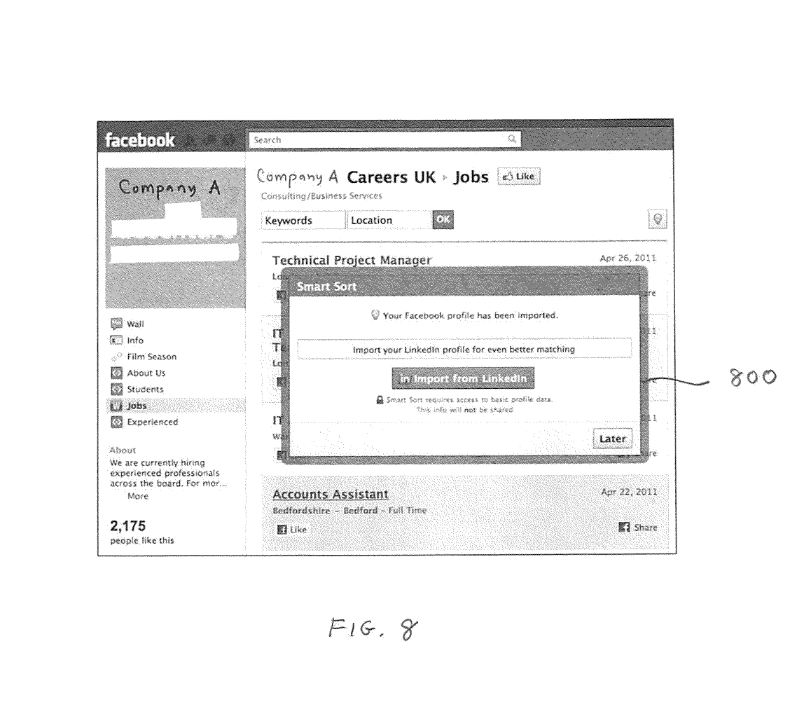

An embodiment can be understood with reference to FIG. 8. FIG. 8 is sample Facebook page of Company A 500 showing a message box 800 prompting the user to increase the accuracy of the application by authorizing access to the LinkedIn profile of the user, according to an embodiment. For example, when the Facebook authorization is complete, the user is prompted to increase the accuracy of job engine 104 and candidate engine 204 by authorizing access to the Linkedin profile of the user.

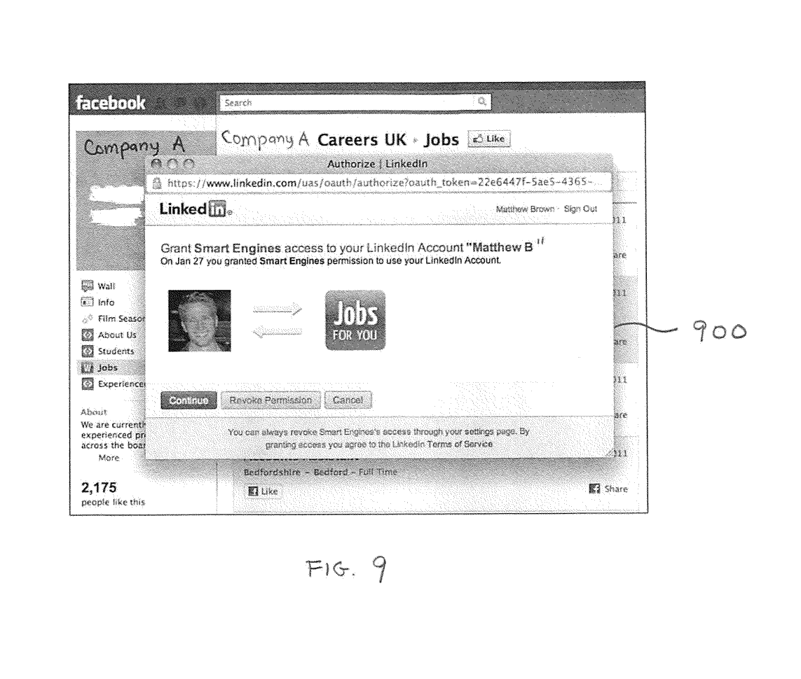

An embodiment can be understood with reference to FIG. 9. FIG. 9 is sample Facebook page of Company A 500 showing a message box 900 that depicts how the authorization for LinkedIn occurs within Facebook and in a manner with which the user already may be familiar and comfortable, according to an embodiment. For example, as with the Facebook authorization process, LinkedIn authorization occurs within Facebook and in a same manner with which users are familiar and comfortable.

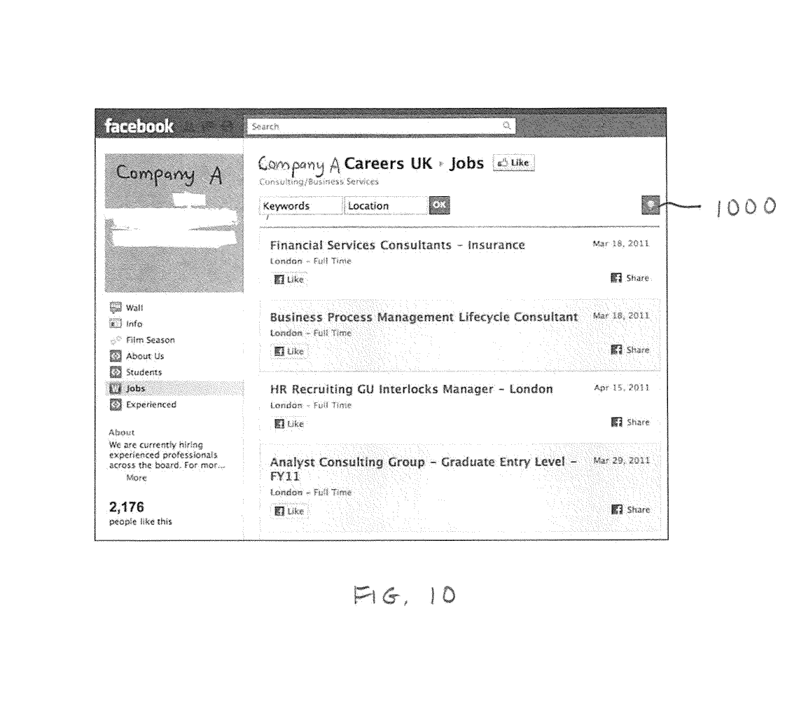

An embodiment can be understood with reference to FIG. 10. FIG. 10 is sample

Facebook page of Company A 500 showing that the light bulb icon in the upper right corner is lit 1000. Such lit light bulb 1000 signals or indicates that the authorization process is complete. Further, in an embodiment, such lit light bulb 1000 may indicate that the displayed list of jobs are reordered based on their relevance to the user.

### Smart Share Workflow

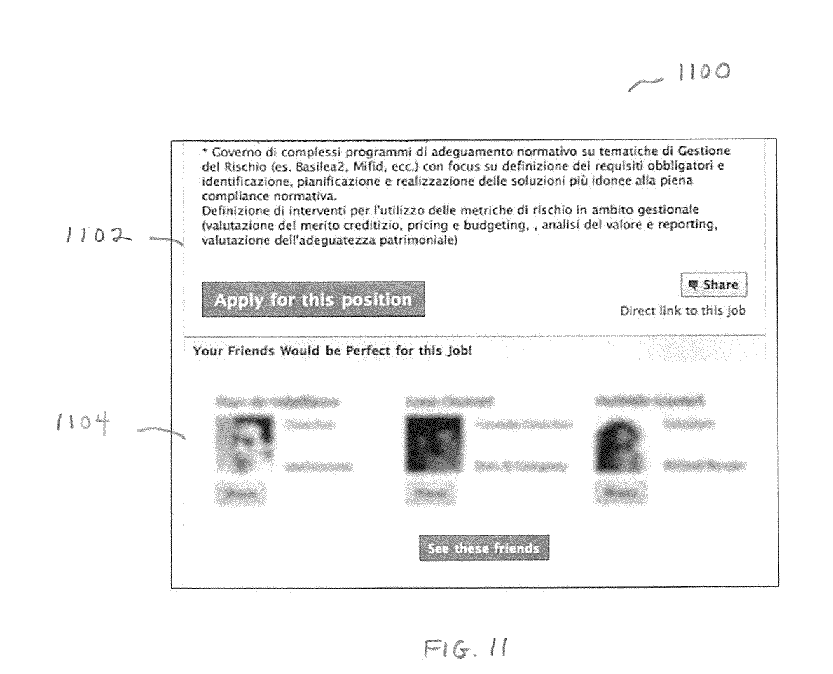

An embodiment can be understood with reference to FIG. 11. FIG. 11 is a sample page on Facebook 1100 of a job posting 1102 and of a list of friends 1104 on Facebook who best match the particular job posting, according to an embodiment. In an embodiment, each job posted on a social network page for a company enables users to identify which friends best match such job. Such functionality uniquely enables a company to leverage employee networks for efficiently and cost-effectively referring top candidates.

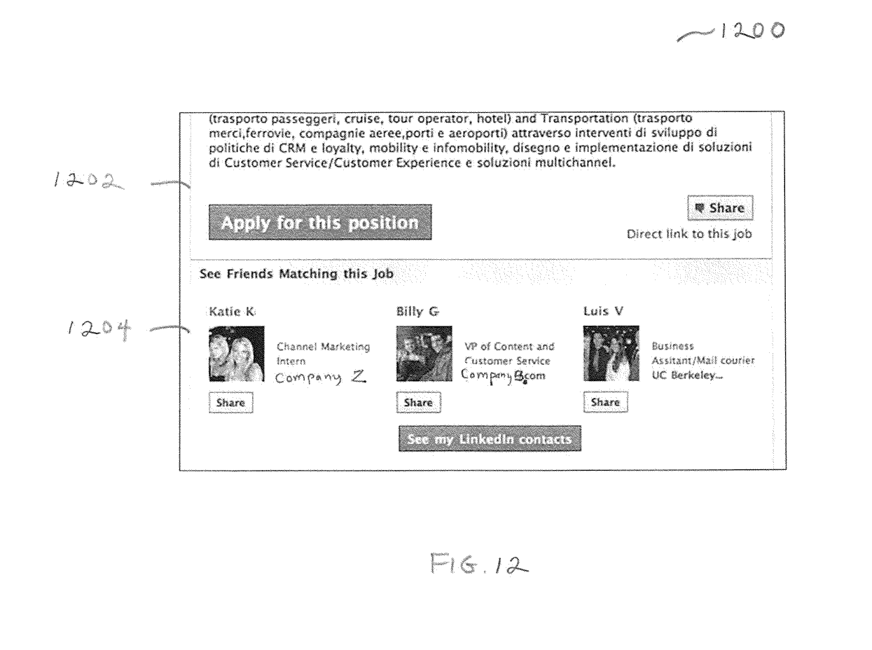

An embodiment can be understood with reference to FIG. 12. FIG. 12 is a sample page on Facebook 1200 of a job posting 1202, a list of friends 1204 that best match the particular job posting, and a link to LinkedIn contacts of the user, according to an embodiment. Employees may activate this feature in less than ten seconds and two clicks. In an embodiment, because the application is running already with respect to the first social network application, such as Facebook, running, the above-discussed proprietary semantic and statistical algorithms match job and LinkedIn candidate profile data.

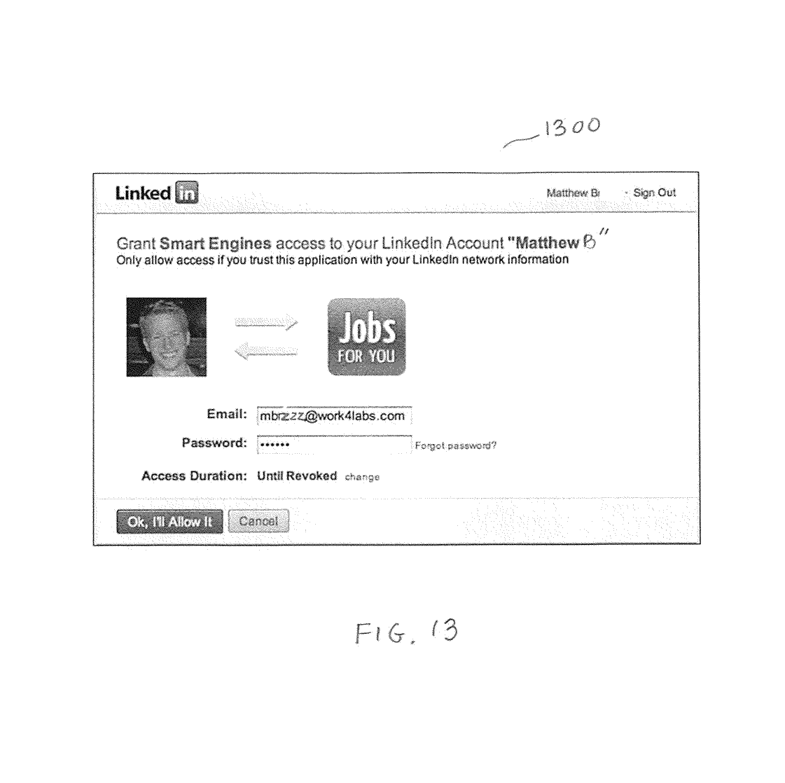

An embodiment can be understood with reference to FIG. 13. FIG. 13 is a sample message box 1300 from LinkedIn asking the user for log in information to the LinkedIn account of the user, according to an embodiment. Embodiments herein use LinkedIn profiles to add additional candidate data and increase the potential number of referrals.

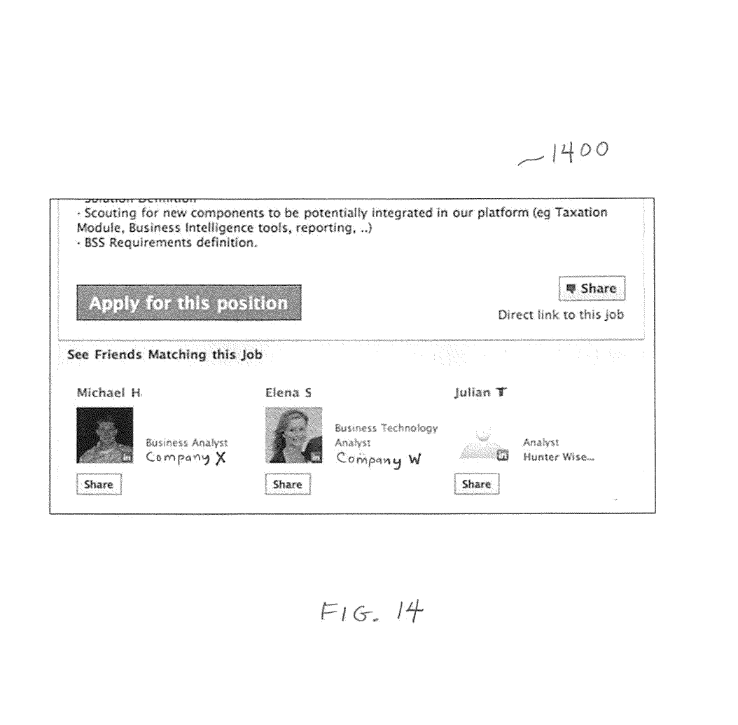

An embodiment can be understood with reference to FIG. 14. FIG. 14 is a sample page on Facebook 1400 of a job posting and of a list of friends in LinkedIn who best match the particular job posting, according to an embodiment. Thus, by using embodiments herein, users see the best referrals for individual jobs across their social networks, such as but not limited to Facebook and LinkedIn networks.

It should further be appreciated that embodiments provide clean and simple interfaces that encourage users to complete the referral.

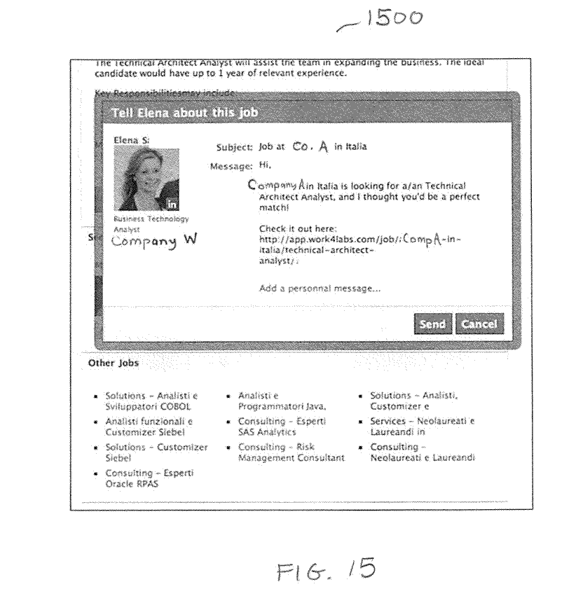

An embodiment can be understood with reference to FIG. 15. FIG. 15 is a sample page on Facebook 1500 that has a dialog box on top that enables the user to send a custom referral within seconds via his or her social networks, such as but not limited to Facebook and LinkedIn, according to an embodiment. Users can send a custom referral within seconds via Facebook or LinkedIn.

In an embodiment, tracking of referrals sent and acted upon is provided. Such tracking may be provided at the employee level or any other level such as but not limited to manager level or top management level.

### An Example Machine Overview

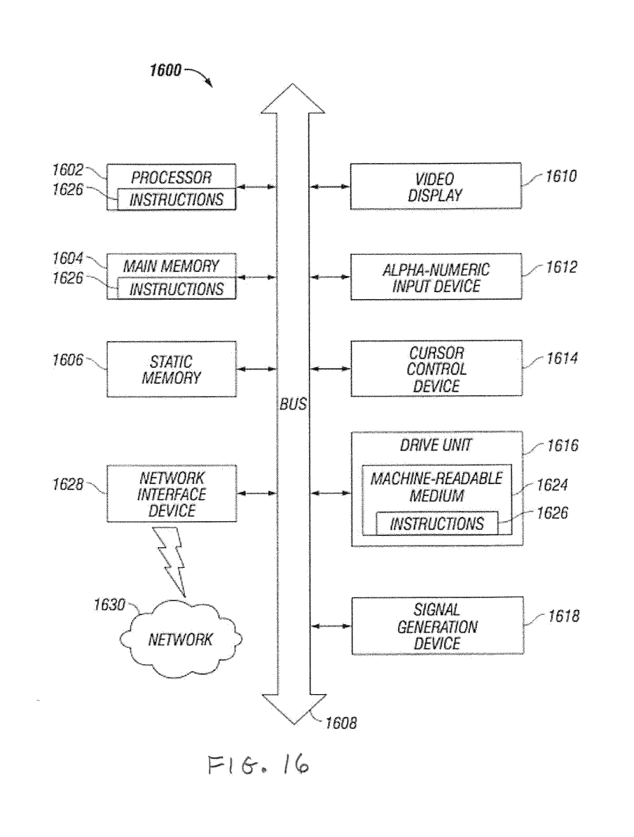

FIG. 16 is a block schematic diagram of a machine in the exemplary form of a computer system 1600 within which a set of instructions may be programmed to cause the machine to execute the logic steps of the invention. In alternative embodiments, the machine may comprise a network router, a network switch, a network bridge, personal digital assistant (PDA), a cellular telephone, a Web appliance or any machine capable of executing a sequence of instructions that specify actions to be taken by that machine.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1620.

The disk drive unit 1616 includes a machine-readable medium 1624 on which is stored a set of executable instructions, i.e. software, 1626 embodying any one, or all, of the methodologies described herein below. The software 1626 is also shown to reside, completely or at least partially, within the main memory 1604 and/or within the processor 1602. The software 1626 may further be transmitted or received over a network 1628, 1630 by means of a network interface device 1620.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Further, it is to be understood that embodiments may include performing operations and using storage with cloud computing. For the purposes of discussion herein, cloud computing may mean executing algorithms on any network that is accessible by internet-enabled or network-enabled devices, servers, or clients and that do not require complex hardware configurations, e.g. requiring cables and complex software configurations, e.g. requiring a consultant to install. For example, embodiments may provide one or more cloud computing solutions that enable users, e.g. users on the go, to access job recruiting social media applications on such internet-enabled or other network-enabled devices, servers, or clients. It further should be appreciated that one or more cloud computing embodiments include job recruiting social media capabilities using mobile devices, tablets, and the like, as such devices are becoming standard consumer devices.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer-implemented method for matching jobs with individuals using data available in social network profiles and semantic and statistical algorithms, comprising the steps of:
generating one or more job description data structures from one or more job descriptions;
generating a candidate description data structure for an individual;
comparing said candidate description data structure against said one or more job description data structures to determine job description data structures that best match said candidate description data structure;
sorting said matching job description data structures in an order that is most relevant to said candidate description data structure, based on said candidate description data structure; and
presenting ordered matching job descriptions to said individual, said ordered matching job descriptions correlating to the ordered matching job description data structures respectively;
wherein a job description data structure comprises standardized components of job requirements that are synthesized into a single classification of a job;
wherein a candidate description data structure comprises standardized components of profiles that are synthesized into a single classification of a type of candidate; and
wherein at least one of the steps is performed by a processor.

2. The computer-implemented method of claim 1, wherein said generating one or more job description data structures further comprises:
receiving said one or more job descriptions as input;
using semantic or statistical algorithms, parsing said input and therefrom identifying one or more keywords that are relevant; and
translating said relevant one or more keywords into said standardized set components of job requirements.

3. The computer-implemented method of claim 1, wherein said generating said candidate description data structure further comprises:
receiving user information from at least one social network as input;
using semantic or statistical algorithms, parsing said input and therefrom identifying professional data and for any identified information that is incomplete, computing information to modify or amend said incomplete information to make said incomplete information complete; and
compiling said identified and complete professional data into said standardized components of profiles.

4. The computer-implemented method of claim 1, further comprising:
presenting an interactive indicator which when selected allows said individual to execute said comparing step;
responsive to said interactive indicator being selected, presenting a message box to said individual asking said individual to select smart sort;
responsive to said smart sort being selected, presenting a message box to said individual asking for permission to access information of the individual from at least one social network; and
responsive to said permission being granted, importing said information.

5. The computer-implemented method of claim 4, further comprising:
responsive to said importing said information, presenting a message box to said individual asking whether the individual desires to include information of the individual from a second social network for more accuracy in said determining said job description data structures that best match said candidate description data structure;
responsive to said desire to include information of the individual from the second social network, presenting a message box to said individual asking for permission to access information of the individual from said at least said second social network; and
responsive to said permission being granted, importing said information from said second network.

6. The computer-implemented method of claim 1, wherein said interactive indicator is a light bulb icon and wherein said light bulb icon is lit when said sorting is complete.

7. An apparatus for matching job with individuals using data available in social network profiles and semantic and statistical algorithms, comprising:
a processor programmed to generate one or more job description data structures from one or more job descriptions;
a processor programmed to generate a candidate description data structure for an individual;
a processor programmed to compare said candidate description data structure against said one or more job description data structures to determine job description data structures that best match said candidate description data structure;
a processor programmed to sort said matching job description data structures in an order that is most relevant to said candidate DNA, based on said candidate description data structure; and
a processor programmed to present ordered matching job descriptions to said individual, said ordered matching job descriptions correlating to the ordered matching job description data structures respectively;
wherein a job description data structure comprises standardized components of job requirements that are synthesized into a single classification of a job; and
wherein a candidate description data structure comprises standardized components of profiles that are synthesized into a single classification of a type of candidate.

8. A tangible computer readable storage medium having stored thereon a computer program for matching job with individuals using data available in social network profiles and semantic and statistical algorithms, said computer program comprising a program code which, when executed by a processor, performs the steps of:
generating one or more job description data structures from one or more job descriptions;
generating a candidate description data structure for an individual;
comparing said candidate description data structure against said one or more job description data structures to determine job description data structures that best match said candidate description data structure;
sorting said matching job description data structures in an order that is most relevant to said candidate description data structure, based on said candidate description data structure; and
presenting ordered matching job descriptions to said individual, said ordered matching job descriptions correlating to the ordered matching job description data structures respectively;
wherein a job description data structure comprises standardized components of job requirements that are synthesized into a single classification of a job; and
wherein a candidate description data structure comprises standardized components of profiles that are synthesized into a single classification of a type of candidate.

9. A computer-implemented method for matching a job posting with one or more friends of an individual of one or more social networks by using data available in social network profiles of the individual and semantic and statistical algorithms, comprising the steps of:
at a job posting page of a company on a social network, providing one or more job description data structures for one or more job postings of said company;
for an individual at said job posting page, generating a candidate description data structure when said individual does not already have a generated candidate description data structure;
in response to said individual selecting a particular job posting, presenting details of said job posting, an indication that one or more friends of said individual on said social network is a match for said particular job, and an interactive indicator, which when selected causes said one or more friends to be presented; and
in response to said interactive indicator being selected, presenting said one or more friends that match said particular job and an interactive indicator for each friend, which when selected causes the particular job posting to be shared with said friend;
wherein at least one of the steps is performed by a processor.

10. The computer-implemented method of claim 9, further comprising:
when said individual is a member of a second network, presenting to said individual an interactive indicator asking whether to present friends of said second network that are a good match for said particular job.

11. The computer-implemented method of claim 10, further comprising:
responsive to said interactive indicator being selected, presenting a message box to said individual requesting access and authorization information of said individual of said second network;
responsive to receiving said access and authorization information, presenting said one or more friends of said second network that match said particular job and an interactive indicator for each friend, which when selected causes the particular job posting to be shared with said friend.

12. The computer-implemented method of claim 10, further comprising:
responsive to sharing said particular job posting to a friend, providing a message box by which the individual sends a custom message to the friend about the referral.

13. An apparatus for matching a job posting with one or more friends of an individual of one or more social networks by using data available in social network profiles of the individual and semantic and statistical algorithms, comprising:
one or more job description data structures for one or more job postings of said company at a job posting page of a company on a social network;
a generating processor programmer to generate a candidate description data structure for an individual at said job posting page when said individual does not have a generated candidate description data structure;
a presenting processor programmed to present, in response to a particular job posting being selected, details of said job posting, an indication that one or more friends of said individual on said social network is a match for said particular job, and an interactive indicator, which when selected causes said one or more friends to be presented; and
a presenting processor programmed to present, in response to said interactive indicator being selected, said one or more friends that match said particular job and an interactive indicator for each friend, which when selected causes the particular job posting to be shared with said friend.

14. A non-transitory computer readable storage medium having stored thereon a computer program for matching a job posting with one or more friends of an individual of one or more social networks by using data available in social network profiles of the individual and semantic and statistical algorithms, said computer program comprising a program code which, when executed by a processor, performs the steps of:
at a job posting page of a company on a social network, providing one or more job description data structures for one or more job postings of said company;
for an individual at said job posting page, generating a candidate description data structure when said individual does not already have a generated candidate description data structure;
in response to said individual selecting a particular job posting, presenting details of said job posting, an indication that one or more friends of said individual on said social network is a match for said particular job, and an interactive indicator, which when selected causes said one or more friends to be presented; and
in response to said interactive indicator being selected, presenting said one or more friends that match said particular job and an interactive indicator for each friend, which when selected causes the particular job posting to be shared with said friend.
